(19) United States
(12) Patent Application Publication
(10) Pub. No.: US 2025/0231757 A1
(43) Pub. Date: Jul. 17, 2025

(54) DETECTING CHANGES TO A CLOUD ENVIRONMENT

(71) Applicant: Capital One Services, LLC., McLean, VA (US)

(72) Inventors: Tao XU, Clarksburg, MD (US); Nesreen MANSOUR, Great Falls, VA (US); Joseph Robert SACCHINI, Reston, VA (US); Siva Prasad KOKA, Sterling, VA (US)

(21) Appl. No.: 18/411,850

(22) Filed: Jan. 12, 2024

(51) Int. Cl. G06F 8/65; H04L 43/06

(52) U.S. Cl. CPC G06F 8/65; H04L 43/06

(57) ABSTRACT

In some implementations, a monitoring system may receive, from a plurality of monitoring instances deployed across a plurality of individual accounts, a set of events associated with the cloud environment. The monitoring system may filter the set of events to generate a filtered set of events and may add the filtered set of events to a queue service. The monitoring system may determine, for each event in the filtered set of events, a corresponding impact. Accordingly, the monitoring system may transmit, for each corresponding impact, a notification to a set of users associated with the corresponding impact.

### BACKGROUND

In a distributed cloud environment, users may propagate changes from individual accounts. Therefore, a change made by one user may have unintended consequences for other users. As a result, the cloud environment may suffer downtime, and administrators may expend lots of power and processing resources to determine a cause of the downtime and to reverse the change.

### SUMMARY

Some implementations described herein relate to a system for detecting changes to a cloud environment. The system may include one or more memories and one or more processors communicatively coupled to the one or more memories. The one or more processors may be configured to receive, from a plurality of monitoring instances deployed across a plurality of individual accounts, a set of events associated with the cloud environment. The one or more processors may be configured to filter the set of events to generate a filtered set of events. The one or more processors may be configured to add the filtered set of events to a queue service. The one or more processors may be configured to determine, for each event in the filtered set of events, a corresponding impact. The one or more processors may be configured to transmit, for each corresponding impact, a notification to a set of users associated with the corresponding impact.

Some implementations described herein relate to a method of detecting changes to a cloud environment. The method may include receiving, from a user device and at a monitoring instance associated with an individual account, an indication of an application programming interface (API) call. The method may include recording, by the monitoring instance, an event associated with a change to the cloud environment, based on the indication of the API call. The method may include transmitting, from the monitoring instance and to a monitoring system associated with a centralized account, the event.

Some implementations described herein relate to a non-transitory computer-readable medium that stores a set of instructions for processing notifications about changes to a cloud environment. The set of instructions, when executed by one or more processors of a device, may cause the device to transmit a set of credentials associated with an individual account. The set of instructions, when executed by one or more processors of the device, may cause the device to transmit, to an instance of the cloud environment associated with the individual account, a command to trigger an API call. The set of instructions, when executed by one or more processors of the device, may cause the device to receive, using a communication software executed by the device, a notification of an impact of the API call.

### BRIEF DESCRIPTION OF THE DRAWINGS

FIGS. 1A-1H are diagrams of an example implementation relating to detecting changes to a cloud environment, in accordance with some embodiments of the present disclosure.

FIG. 2 is a diagram of an example user interface associated with a notification of an impact corresponding to an event associated with a cloud environment, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to detecting changes to a cloud environment, in accordance with some embodiments of the present disclosure.

FIG. 6 is a flowchart of an example process relating to reporting changes to a cloud environment, in accordance with some embodiments of the present disclosure.

FIG. 7 is a flowchart of an example process relating to commanding changes to a cloud environment, in accordance with some embodiments of the present disclosure.

### DETAILED DESCRIPTION

The following detailed description of example implementations refers to the accompanying drawings. The same reference numbers in different drawings may identify the same or similar elements.

In a distributed cloud environment, users may propagate changes from individual accounts. For example, a user may change a security group (e.g., deleting the security group, adding to and/or subtracting from the security group, or creating a new security group) and/or change code relevant to the cloud environment (e.g., patching or updating a cloud-based application, among other examples). The user's change, however, may propagate to other components of the cloud environment (e.g., via application and other dependencies) and/or other users of the cloud environment (e.g., who use the security group modified by the user). As a result, a change from one user may have unintended consequences for other users. As a result, the cloud environment may suffer downtime, and administrators may expend lots of power and processing resources to determine a cause of the downtime and to reverse the change.

However, restricting users' abilities to make changes could result in security vulnerabilities. For example, when cloud-based applications go unpatched, the cloud-based applications may become subject to attacks. In another example, out-of-date security groups may allow bad actors to exploit the security groups to gain unauthorized access to the cloud environment.

Some implementations described herein enable a monitoring system (e.g., associated with a centralized account of a cloud environment) to receive events caused by changes to the cloud environment. For example, each user in the cloud environment may have a monitoring instance deployed to an individual account associated with the user, and each monitoring instance may report application programming interface (API) calls, triggered by the user, to the monitoring system. As a result, the monitoring system may determine impacts of changes propagated by users of the cloud environment and proactively report the impacts (e.g., to administrators). As a result, the cloud environment experiences reduced downtime because problems that will be caused by a change may be predicted and prevented. Additionally, power and processing resources are conserved that otherwise would have been spent in determining causes of downtime and restoring the cloud environment (e.g., by reversing changes from the users).

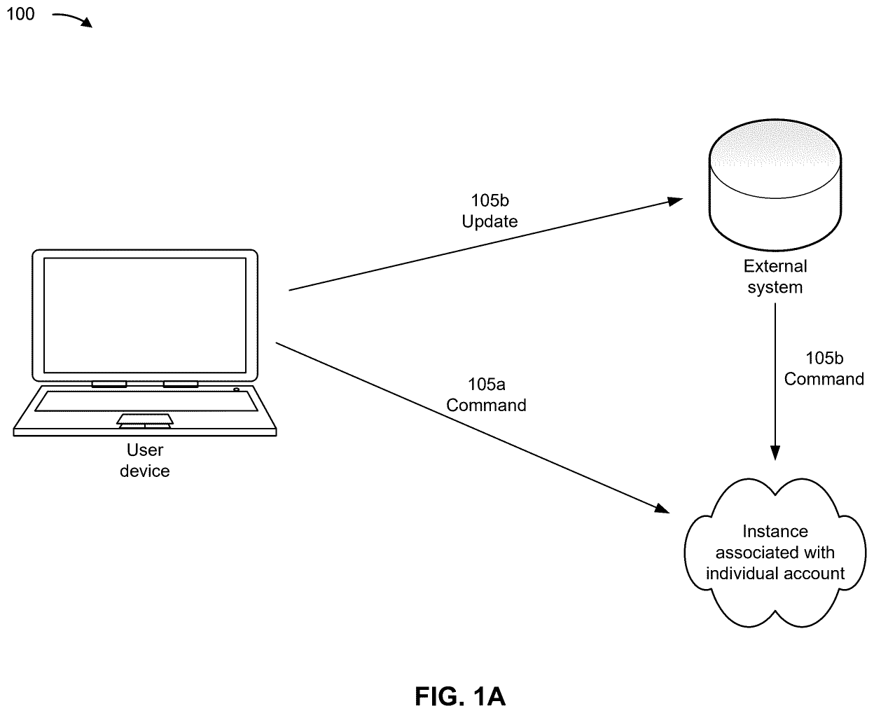

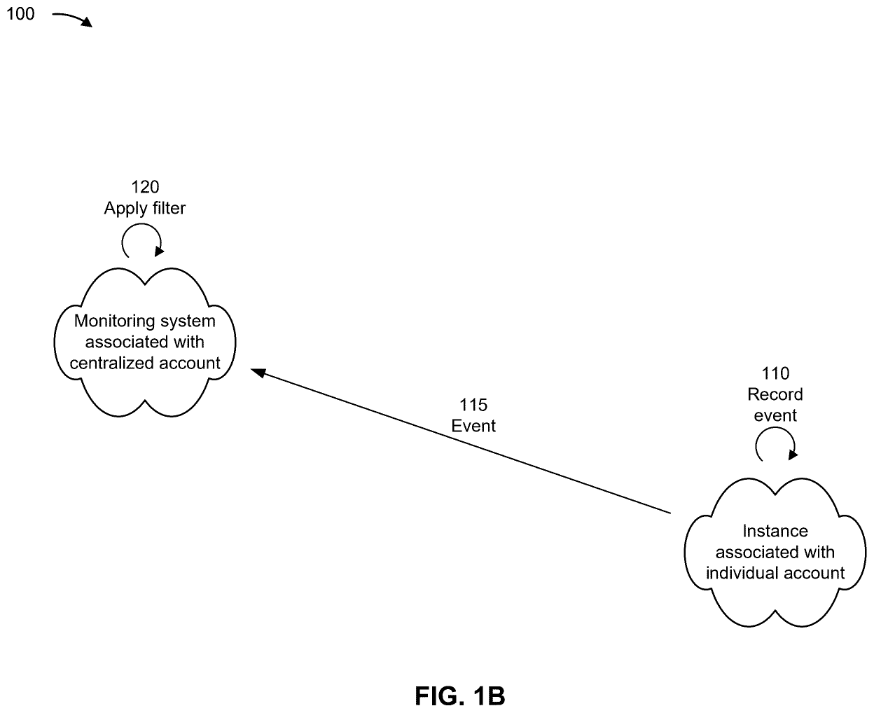

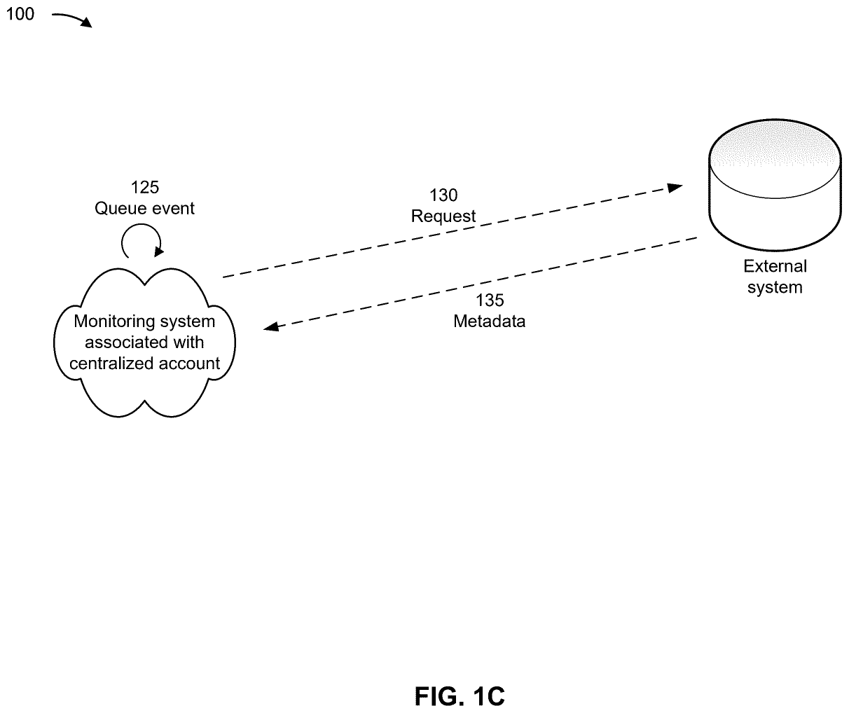

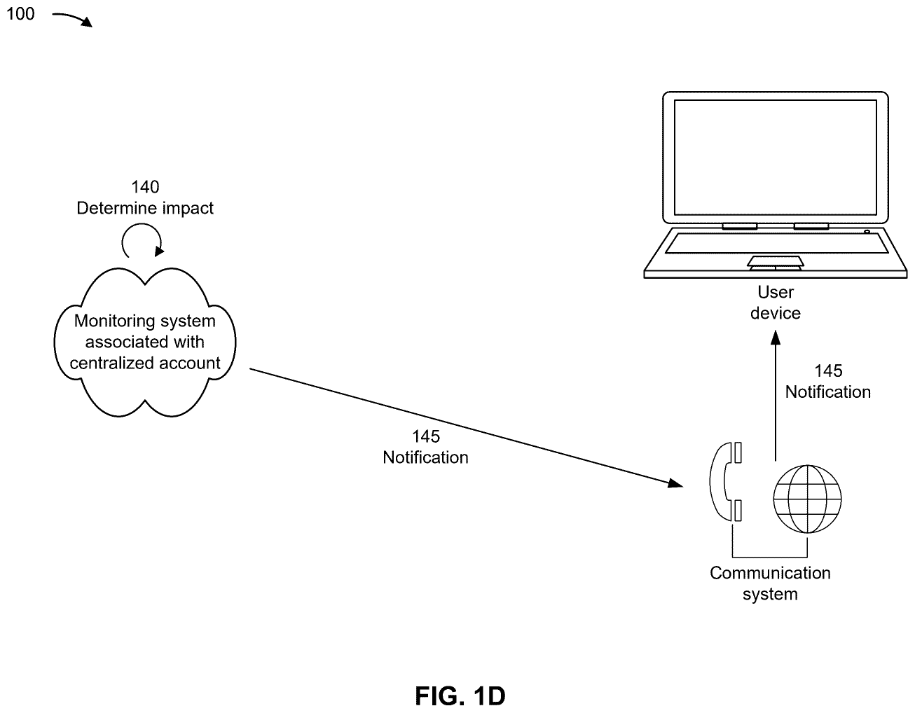

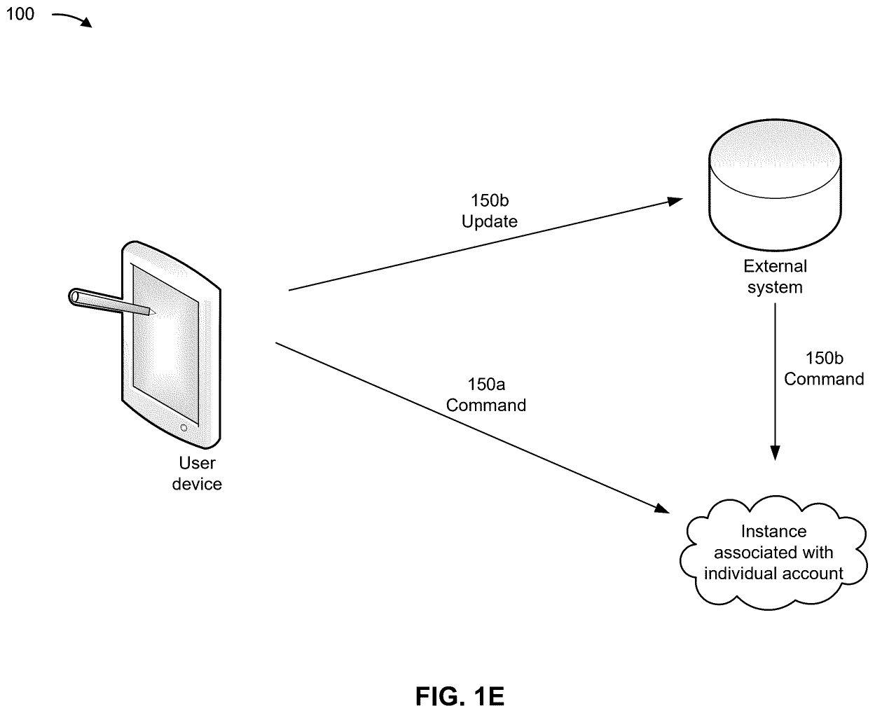

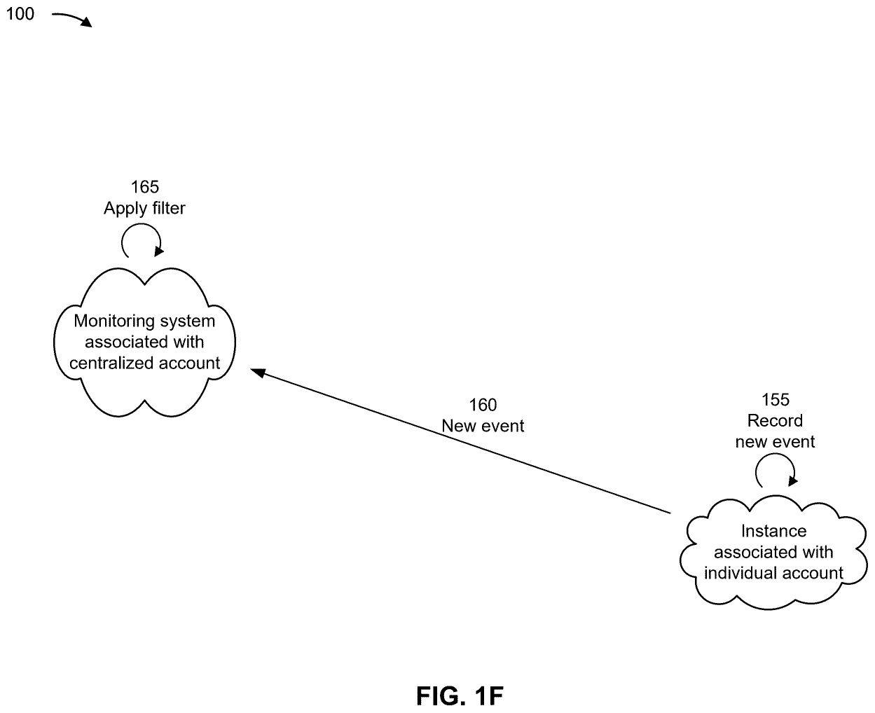

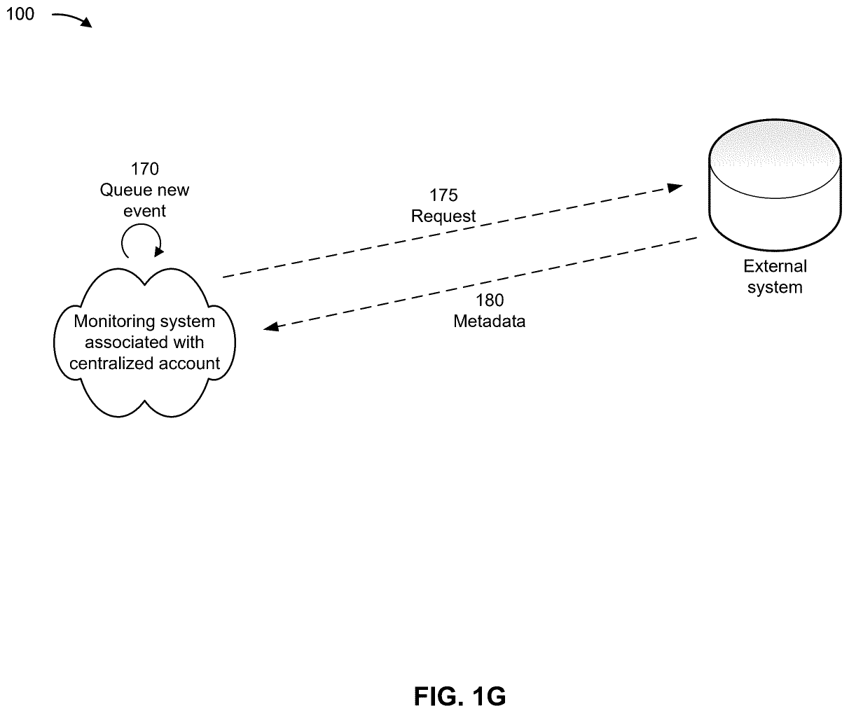

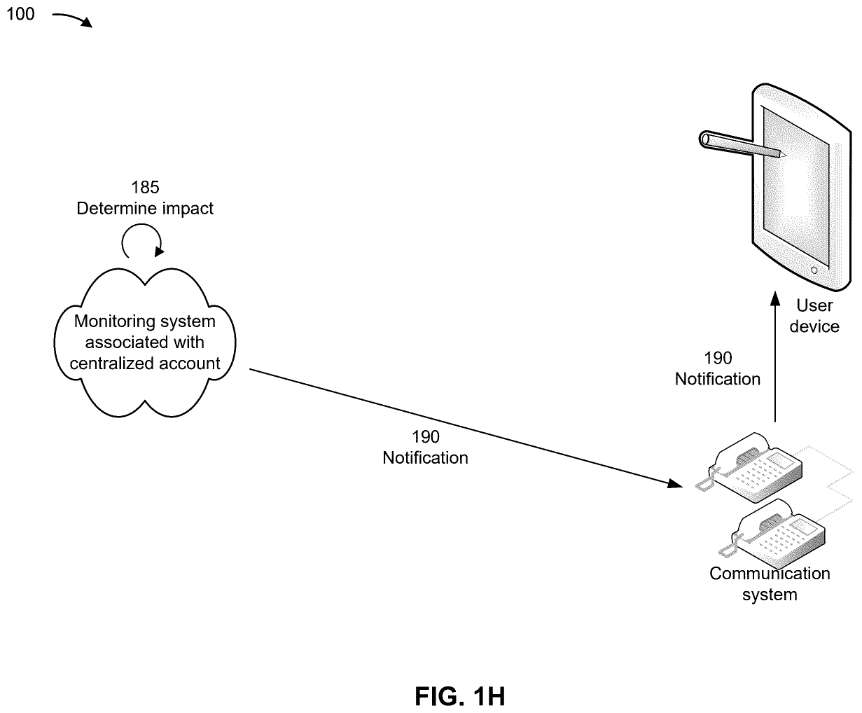

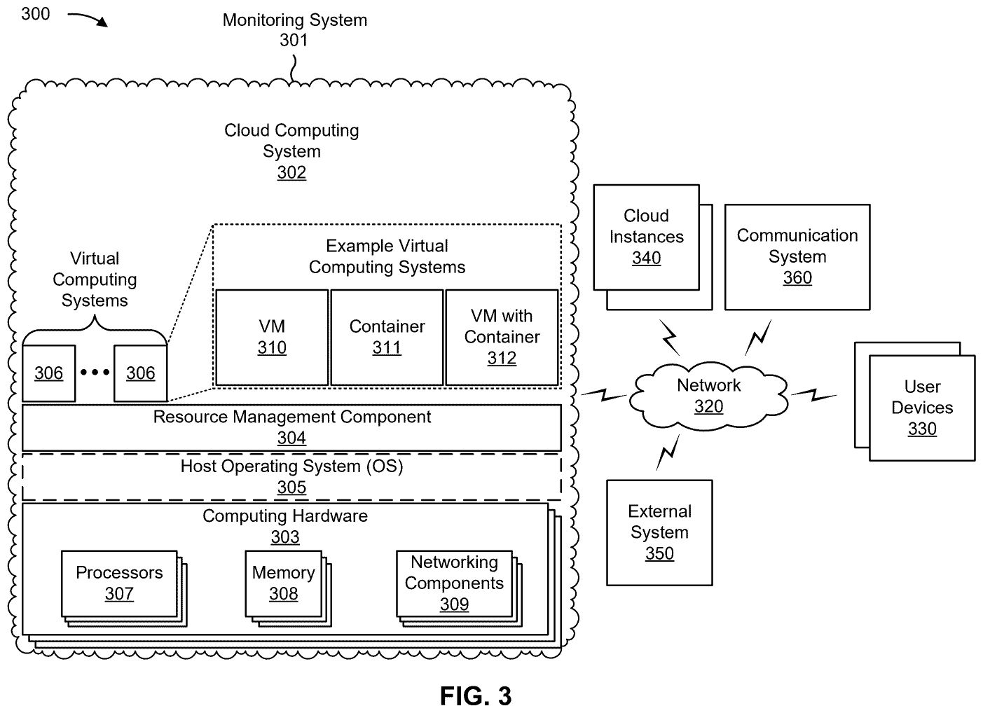

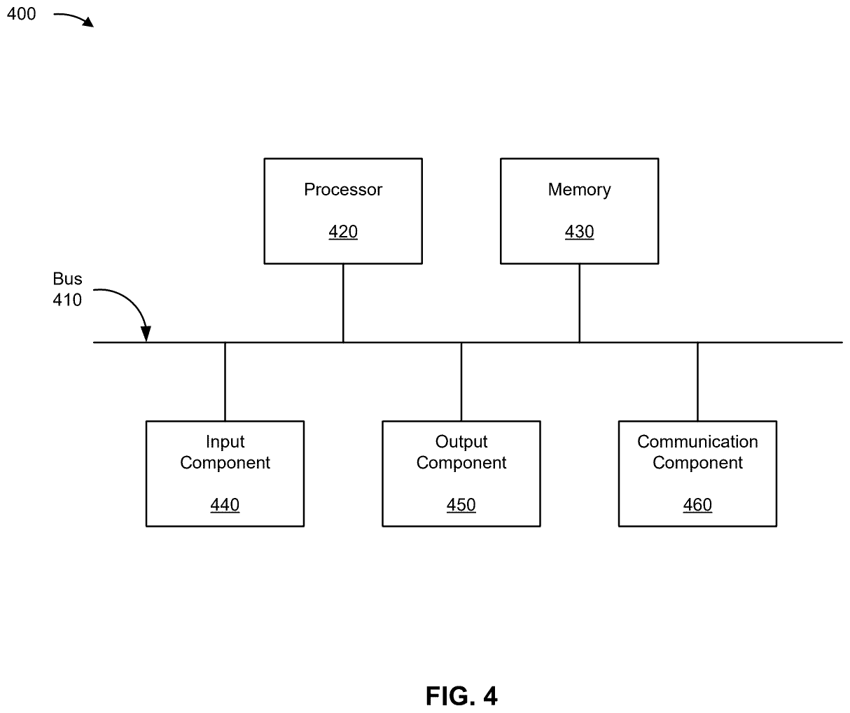

FIGS. 1A-1H are diagrams of an example 100 associated with detecting changes to a cloud environment. As shown in FIGS. 1A-1H, example 100 includes a set of user devices, an external system, a cloud environment supporting a set of instances (e.g., associated with individual accounts), a monitoring system (e.g., associated with a centralized account), and a communication system. These devices are described in more detail in connection with FIGS. 3 and 4.

As shown in FIG. 1A and by reference number 105a, a first user device may transmit, and a first instance (e.g., associated with an individual account of a first user of the first user device) may receive, a command to trigger an API call. In some implementations, the first user may provide input (e.g., using an input component of the first user device) that triggers the first user device to transmit the command. For example, the first user may provide the input using a terminal window, a bash shell, or another type of command line. Therefore, the command may be an update to a cloud configuration (e.g., associated with the cloud environment) using the command line. In another example, a web browser (and/or another application executed by the first user device) may navigate to a website controlled by (or at least associated with) the first instance and may output a console (e.g., using an output component of the first user device) to the first user. Therefore, the first user may interact with the console, and the first user device may detect interaction with the console and transmit the command in response to the interaction. Therefore, the command may be an update to the cloud configuration using the console. Additionally, or alternatively, the first user device may transmit the command automatically. For example, the first user device may transmit the command periodically (e.g., according to a schedule, whether a default schedule or a schedule configured by the first user). In another example, the first user device may transmit the command in response to a trigger event.

In some implementations, the first user device may transmit, and the first instance may receive, a set of credentials (e.g., associated with the individual account). The set of credentials may include a username and password, a single sign-on (SSO) request, a certificate, a private key, and/or biometric information, among other examples. Therefore, the first instance may verify the set of credentials before receiving the command. Alternatively, the first user device may transmit the set of credentials in a same message as the command, and the first instance may process the command in response to verifying the set of credentials.

As an alternative, and as shown by reference number 105b, the first user device may transmit, and the external system may receive, an update to a binary (e.g., associated with the first instance). For example, the external system may include a code repository, and the update may include a code change, a compilation command, and/or a pull request (PR), among other examples. Accordingly, as further shown by reference number 105b, the external system may transmit, and the first instance may receive, the command to trigger the API call. For example, the external system may forward the command from the first user device (e.g., included in the update to the binary). Alternatively, the external system may generate the command, based on the update to the binary, and transmit the command.

Therefore, a first monitoring instance (e.g., associated with the individual account of the first user of the first user device) may receive an indication of the API call. The first monitoring instance may have been configured by the monitoring system. For example, the monitoring system may have transmitted, and the first instance may have received, a command to deploy the first monitoring instance. Additionally, the monitoring system may have transmitted, and the first instance may have received, a configuration for the first monitoring instance. Therefore, the first monitoring instance may subscribe to API events within the first instance.

As shown in FIG. 1B and by reference number 110, the first monitoring instance may record an event, associated with the cloud environment, based on the indication of the API call. For example, the first monitoring instance may receive indications whenever API functions are called within (and/or by) the first instance. In some implementations, the first monitoring instance may record the event using the configuration (e.g., from the monitoring system, as described above). For example, the configuration may indicate some types of API calls to record (e.g., commands to change and/or update the cloud environment) and other types of API calls to ignore (e.g., status requests, among other examples). The configuration may therefore indicate a rule (e.g., at least one rule) that specifies a pattern (e.g., at least one pattern). The event is recorded based on the event satisfying the rule (that is, in response to the rule matching the pattern). As used herein, “match” refers to a perfect match or a fuzzy match (e.g., matching within a margin of error and/or differing by an amount that satisfies a fuzzy match threshold, among other examples).

As shown by reference number 115, the first monitoring instance may transmit, and the monitoring system may receive, the event. The event may be transmitted in a hypertext transmit protocol (HTTP) message and/or using an API call. In some implementations, the first monitoring instance may transmit the event in response to recording the event. In other words, the monitoring system may receive the event in real-time (or in near-real-time) because the first monitoring instance transmits recorded events as available.

As shown by reference number 120, the monitoring system may apply a filter to the event. The filter may include a rule (e.g., at least one rule) that specifies a pattern (e.g., at least one pattern). The pattern specified at the monitoring system may be more restrictive than the pattern specified at the first monitoring instance (that is, fewer events match the pattern at the monitoring system as compared with the pattern at the first monitoring instance). Some examples of events that pass the filter may include configuration changes associated with the cloud environment, a container task definition update, or a lambda function version update, among other examples.

As shown in FIG. 1C and by reference number 125, the monitoring system may add the event (after filtering) to a queue service. The queue service may ensure that each event (after filtering) is processed once (and, preferably, only once). The queue service may include Amazon® Simple Queue Service (SQS) or Microsoft Azure® Queue Storage, among other examples.

In some implementations, the monitoring system may directly proceed to determining a corresponding impact associated with the event (e.g., in response to the event being next in the queue service). Alternatively, the monitoring system may request additional information in order to determine the corresponding impact. For example, the event may include an update to a binary, as described above, and the monitoring system may use metadata associated with the update to determine the corresponding impact. As used herein, “metadata” refers to data that provides information about the API call (e.g., triggered by a user) and is not included in the event (e.g., recorded by a monitoring instance).

For example, as shown by reference number 130, the monitoring system may transmit, and the external system may receive, a request for the metadata. For example, the external system may be a code repository, such that the metadata includes code changes triggered by the API call (and not included in the event itself). The request may include an HTTP request, a file transfer protocol (FTP) request, and/or an API call. The request may indicate (e.g., in a header and/or as an argument) the event. As shown by reference number 135, the external system may transmit, and the monitoring system may receive, the metadata. The external system may transmit, and the monitoring system may receive, the metadata in response to the request from the monitoring system. The metadata may be transmitted (and received) in an HTTP response, in an FTP response, and/or as a return from an API function.

Additionally, or alternatively, the monitoring system may receive metadata, associated with the event, from the first monitoring instance. For example, the monitoring system may transmit, and the first monitoring instance may receive, a request for the metadata. Accordingly, the first monitoring instance may transmit, and the monitoring system may receive, the metadata (e.g., in response to the request from the monitoring system). Additionally, or alternatively, the monitoring system may receive metadata, associated with the event, from the user device. For example, the monitoring system may transmit, and the user device may receive, a request for the metadata. Accordingly, the user device may transmit, and the monitoring system may receive, the metadata (e.g., in response to the request from the monitoring system).

As shown in FIG. 1D and by reference number 140, the monitoring system may determine, for the event, a corresponding impact. In some implementations, the monitoring system may determine the corresponding impact directly from the event. For example, the event may include a cloud configuration event, and the monitoring system may extract the corresponding impact from the event. Additionally, or alternatively, the monitoring system may determine the corresponding impact based on the metadata (associated with the event). For example, the event may include a binary update event, and the monitoring system may determine the corresponding impact based on which portions of code were changed (e.g., by the update from the first user device, as described in connection with reference number 105b).

Additionally, or alternatively, the monitoring system may determine the corresponding impact based on a dependency mapping. For example, the corresponding impact may include a list of affected applications, for the event, determined using the dependency mapping. In one example, the dependency mapping may include a data structure (e.g., a relational data structure and/or a graph, among other examples) that represents data flows between applications in the cloud environment. Accordingly, the monitoring system may determine the list of affected applications based on upstream and downstream connections between an application that has changed and other applications in the dependency mapping. In another example, the dependency mapping may include clusters of applications in the cloud environment (e.g., in which nodes represent the applications). Accordingly, the monitoring system may determine the list of affected applications as a list of nearest neighbors to an application that has changed. In another example, the monitoring system may track data flows between applications in the cloud environment. Accordingly, the monitoring system may determine the list of affected applications based on which applications have recently sent data to, and/or received data from, an application that has changed.

Additionally, or alternatively, the monitoring system may determine the corresponding impact using a machine learning model. The monitoring system may provide the event (and the metadata, when available) to the machine learning model. For example, the monitoring system may transmit, and a machine learning host (e.g., that provides the machine learning model) may receive, a request including the event (and the metadata, if available). Therefore, the compliance system may receive an indication of the corresponding impact from the machine learning model (e.g., from the machine learning host).

The machine learning model may be trained (e.g., by the machine learning host and/or a device at least partially separate from the machine learning host) using a labeled set of events (e.g., for supervised learning). Additionally, or alternatively, the machine learning model may be trained using an unlabeled set of events (e.g., for deep learning). The machine learning model may be configured to determine the corresponding impact for the event. In one example, the machine learning model may be configured to compare the event to previous events (e.g., in order to determine the corresponding impact based on the comparison). Additionally, or alternatively, the machine learning model may be configured to cluster the event with previous events (e.g., in order to determine the corresponding impact based on which cluster includes the event).

In some implementations, the machine learning model may include a regression algorithm (e.g., linear regression or logistic regression), which may include a regularized regression algorithm (e.g., Lasso regression, Ridge regression, or Elastic-Net regression). Additionally, or alternatively, the machine learning model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., a set of previous events). For example, for a regression algorithm, a model parameter may include a regression coefficient (e.g., a weight). For a decision tree algorithm, a model parameter may include a decision tree split location, as an example.

Additionally, the machine learning host (and/or a device at least partially separate from the machine learning host) may use one or more hyperparameter sets to tune the machine learning model. A hyperparameter may include a structural parameter that controls execution of a machine learning algorithm by the cloud management device, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

The monitoring system may output a notification to the first user (and/or a set of other users) associated with the corresponding impact. The set of other users may include a tech lead associated with a team that includes the first user. Additionally, or alternatively, the set of other users may be included in teams (e.g., one or more teams) responsible for applications on the list of affected applications. The monitoring system may identify the set of other users with a data structure (e.g., a table or another type of relational structure, and/or a graph or another type of NoSQL structure, among other examples) that associates applications with users and/or that associates users with tech leads.

In some implementations, the monitoring system may also estimate a time-to-recover associated with the corresponding impact. The time-to-recover may include a range (e.g., 1 minute to 5 minutes, or 10 minutes to 20 minutes, among other examples) or a particular value (e.g., 5 minutes, or 10 minutes, among other examples). In one example, the machine learning model described above may generate the time-to-recover in addition to the corresponding impact. In another example, the monitoring system may estimate the time-to-recover based on an amount of time to reverse the command (and/or the update) from the first user. Therefore, the notification may further indicate the time-to-recover.

As shown by reference number 145, the monitoring system may transmit the notification to the first user device via the communication system. For example, the first user may have indicated a preference (e.g., stored in a data structure accessible by the monitoring system) for a communication channel associated with the communication system (e.g., a preference for email messages, text messages, and/or chat messages, among other examples). Therefore, the monitoring system may use the communication system based on the preference. In some implementations, the first user device may receive the notification using a communication software executed by the first user device. The communication software may be executed by the first user device separately from software that transmits the command and/or the update, as described in connection with FIG. 1A. For example, the first user device may receive the notification using Slack®, Microsoft Outlook®, and/or another type of communication software that is separate from command line software, console software, and/or another type of software that is used to transmit the command and/or the update.

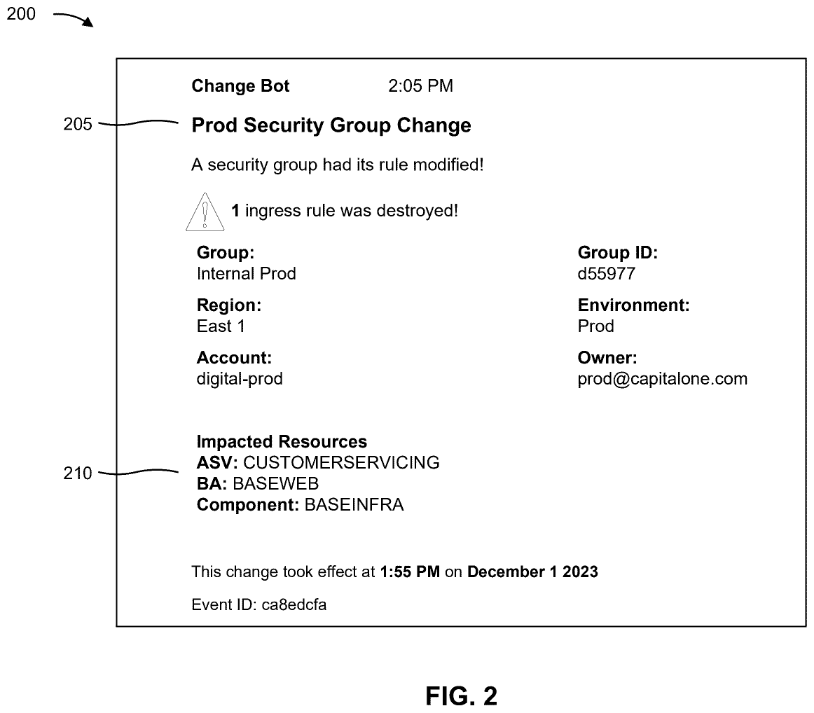

In some implementations, the first user device may output (to the first user) a user interface (UI) including the notification. The UI may be as described in connection with FIG. 2. Accordingly, the UI may display a chat message. Additionally, or alternatively, the UI may display an email message or a text message, among other examples.

The monitoring system may therefore proactively report the corresponding impact. As a result, the cloud environment may experience reduced downtime because problems that may be caused by the change (and/or the update) from the first user may be detected early and prevented. Additionally, power and processing resources are conserved that otherwise would have been spent in determining causes of downtime and restoring the cloud environment (e.g., by reversing changes from the users).

The monitoring system may scale to track events across a plurality of individual accounts. For example, the operations described in connection with FIGS. 1E-1H may be simultaneous (or at least concurrent, that is, at least partially overlapping in time) with the operations described in connection with FIGS. 1A-1D. As shown in FIG. 1E and by reference number 150a, a second user device may transmit, and a second instance (e.g., associated with an individual account of a second user of the second user device) may receive, a command to trigger an additional API call. As an alternative, and as shown by reference number 150b, the second user device may transmit, and the external system may receive, an update to an additional binary (e.g., associated with the second instance). Accordingly, as further shown by reference number 150b, the external system may transmit, and the second instance may receive, the command to trigger the additional API call.

Therefore, a second monitoring instance (e.g., associated with the individual account of the second user of the second user device) may receive an indication of the additional API call. The second monitoring instance may have been configured by the monitoring system. For example, the monitoring system may have transmitted, and the second instance may have received, a command to deploy the second monitoring instance. Additionally, the monitoring system may have transmitted, and the second instance may have received, a configuration for the second monitoring instance. Therefore, the second monitoring instance may subscribe to API events within the second instance.

As shown in FIG. 1F and by reference number 155, the second monitoring instance may record a new event, associated with the cloud environment, based on the indication of the API call. As shown by reference number 160, the second monitoring instance may transmit, and the monitoring system may receive, the new event. Additionally, as shown by reference number 165, the second monitoring instance may apply a filter to the new event. The filter may be the same filter as described in connection with reference number 120 or a different filter.

As shown in FIG. 1G and by reference number 170, the monitoring system may add the new event (after filtering) to the queue service. In some implementations, the monitoring system may request, and receive, metadata associated with the new event, as shown by reference numbers 175 and 180, respectively.

As shown in FIG. 1H and by reference number 185, the monitoring system may determine, for the new event, a corresponding impact. Additionally, the monitoring system may output a notification to the second user (and/or a set of other users) associated with the corresponding impact. The set of other users may be the same set as described in connection with FIG. 1D or a different set. As shown by reference number 190, the monitoring system may transmit the notification to the second user device via the communication system. The communication system may be the same communication system as described in connection with FIG. 1D or a different communication system. In some implementations, the second user device may output (to the second user) a UI including the notification. The UI may be as described in connection with FIG. 2. Accordingly, the UI may display a chat message. Additionally, or alternatively, the UI may display an email message or a text message, among other examples.

The monitoring system may be scaled even beyond two users. For example, the monitoring system may receive a set of events, associated with the cloud environment, from a plurality of monitoring instances deployed across a plurality of individual accounts. The monitoring system may filter the set of events to generate a filtered set of events and may add the filtered set of events to the queue service. Using the queue service allows the monitoring system to prepare events, in the set of events, for batching (e.g., the events are parsed and corresponding impacts determined in batches rather than individually. Moreover, the monitoring system may determine, for each event in the filtered set of events, a corresponding impact, and may transmit, for each corresponding impact, a notification to a set of users associated with the corresponding impact.

Scaling the monitoring system may result in the monitoring system receiving the set of events from the plurality of monitoring instances (e.g., deployed to the plurality of individual accounts). As a result, the monitoring system may determine corresponding impacts of changes propagated by users of the cloud environment and proactively report the impacts (e.g., to the set of users associated with each corresponding impact). As a result, the cloud environment experiences reduced downtime because problems that will be caused by the changes may be predicted and prevented. Additionally, power and processing resources are conserved that otherwise would have been spent in determining causes of downtime and restoring the cloud environment (e.g., by reversing changes from the users).

As indicated above, FIGS. 1A-1H are provided as an example. Other examples may differ from what is described with regard to FIGS. 1A-1H. For example, the queue service may be omitted such that the monitoring system directly processes events (after filtering) as the events arrive.

FIG. 2 is a diagram of an example UI 200 associated with a notification of an impact corresponding to an event associated with a cloud environment. The example UI 200 may be shown by a user device (e.g., based on instructions from a monitoring system). These devices are described in more detail in connection with FIGS. 3 and 4.

As shown in FIG. 2, the example UI 200 may include an indication 205 of a change to a cloud environment. In FIG. 2, the change is to a security group, but other changes may include different updates to a configuration of the cloud environment and/or updates to binaries, among other examples. The example UI 200 may further include details about the change, such as a group associated with the change (e.g., a team including a user that made the change) (shown as “Group” and “Group ID”), a region associated with the change (e.g., a region including an individual account of the user that made the change) (shown as “Region”), the individual account associated with the change (shown as “Account”), an environment associated with the change (shown as “Environment”), and an owner associated with the change (shown as “Owner”).

As further shown in FIG. 2, the example UI 200 may include an indication 210 of a list of affected applications (e.g., shown as “ASV” or application service, “BA” or business analytics, and “Component” referring to cloud infrastructure, such as a host operating system (OS) or another underlying piece of software and/or hardware). Additional details, such as a time associated with the change and an event identifier (“event ID”) associated with the change, may be included in the example UI 200.

As indicated above, FIG. 2 is provided as an example. Other examples may differ from what is described with regard to FIG. 2. For example, any information shown in FIG. 2 may be omitted in other examples.

FIG. 3 is a diagram of an example environment 300 in which systems and/or methods described herein may be implemented. As shown in FIG. 3, environment 300 may include a monitoring system 301, which may include one or more elements of and/or may execute within a cloud computing system 302. The cloud computing system 302 may include one or more elements 303-312, as described in more detail below. As further shown in FIG. 3, environment 300 may include a network 320, a set of user devices 330, a set of cloud instances 340, an external system 350, and/or a communication system 360. Devices and/or elements of environment 300 may interconnect via wired connections and/or wireless connections.

The cloud computing system 302 may include computing hardware 303, a resource management component 304, a host OS 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the monitoring system 301 may include one or more elements 303-312 of the cloud computing system 302, may execute within the cloud computing system 302, and/or may be hosted within the cloud computing system 302, in some implementations, the monitoring system 301 may not be cloud-based (e.g., may be implemented outside of a cloud computing system) or may be partially cloud-based. For example, the monitoring system 301 may include one or more devices that are not part of the cloud computing system 302, such as device 400 of FIG. 4, which may include a standalone server or another type of computing device. The monitoring system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The set of user devices 330 may include one or more devices capable of receiving, generating, storing, processing, and/or providing information associated with API calls, as described elsewhere herein. The set of user devices 330 may include a set of communication devices and/or computing devices. For example, the set of user devices 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The set of user devices 330 may communicate with one or more other devices of environment 300, as described elsewhere herein.

The set of cloud instances 340 may include one or more devices capable of receiving, generating, storing, processing, providing, and/or routing information associated with events, as described elsewhere herein. The set of cloud instances 340 may include computing hardware used in a cloud computing environment. For example, the set of cloud instances 340 may be supported by a same set of computing hardware as the monitoring system 301 is supported by (which, for example, may be associated with a centralized account). Each cloud instance in the set of cloud instances 340 may be associated with an individual account and may support a corresponding monitoring instance (e.g., as described in connection with FIGS. 1A-1H). Each monitoring instance may include Amazon CloudWatch or Microsoft Azure Monitor, among other examples. The set of cloud instances 340 may communicate with one or more other devices of environment 300, as described elsewhere herein.

The external system 350 may include one or more devices capable of receiving, generating, storing, processing, and/or providing information associated with metadata and/or code, as described elsewhere herein. For example, the external system 350 may include Github® or SourceForge®, among other examples. The external system 350 may include a communication device and/or a computing device. For example, the external system 350 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The external system 350 may communicate with one or more other devices of environment 300, as described elsewhere herein.

The communication system 360 may include one or more devices capable of receiving, processing, storing, routing, and/or providing traffic (e.g., a packet and/or other information or metadata) in a manner described herein. For example, the communication system 360 may include a router, such as a label switching router (LSR), a label edge router (LER), an ingress router, an egress router, a provider router (e.g., a provider edge router or a provider core router), a virtual router, or another type of router. Additionally, or alternatively, the communication system 360 may include a gateway, a switch, a firewall, a hub, a bridge, a reverse proxy, a server (e.g., a proxy server, a cloud server, or a data center server), a load balancer, and/or a similar device. In some implementations, the communication system 360 may be a physical device implemented within a housing, such as a chassis. In some implementations, the communication system 360 may be a virtual device implemented by one or more computing devices of a cloud computing environment or a data center. The communication system 360 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with detecting changes to a cloud environment. The device 400 may correspond to a user device 330, a device supporting a cloud instance 340, an external system 350, and/or a communication system 360. In some implementations, a user device 330, a device supporting a cloud instance 340, an external system 350, and/or a communication system 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

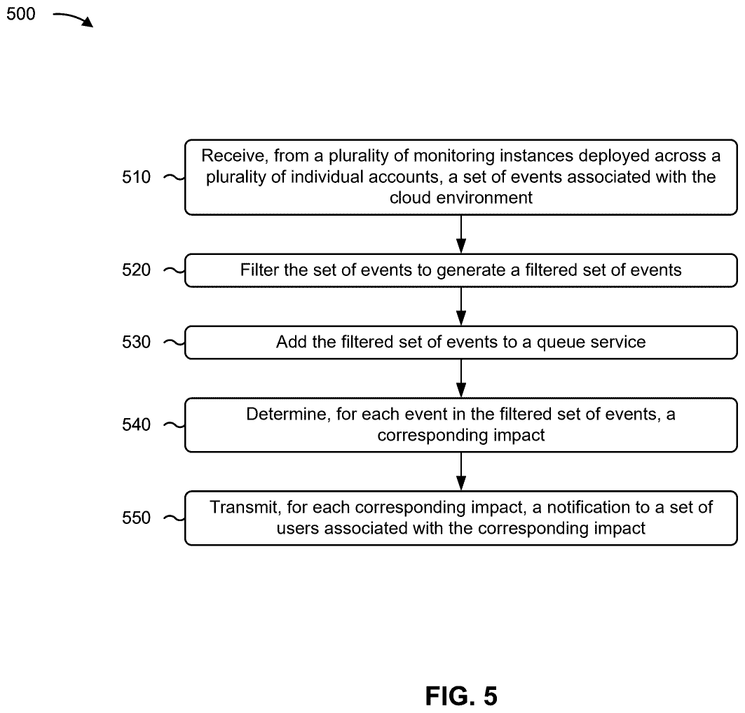

FIG. 5 is a flowchart of an example process 500 associated with detecting changes to a cloud environment. In some implementations, one or more process blocks of FIG. 5 may be performed by a monitoring system 301. In some implementations, one or more process blocks of FIG. 5 may be performed by another device or a group of devices separate from or including the monitoring system 301, such as a user device 330, a device supporting a cloud instance 340, an external system 350, and/or a communication system 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a plurality of monitoring instances deployed across a plurality of individual accounts, a set of events associated with the cloud environment (block 510). For example, the monitoring system 301 (e.g., using processor 420, memory 430, and/or communication component 460) may receive, from a plurality of monitoring instances deployed across a plurality of individual accounts, a set of events associated with the cloud environment, as described above in connection with reference number 115 of FIG. 1B and/or reference number 160 of FIG. 1F. As an example, the set of events may be received in HTTP messages and/or using API calls. In some implementations, the plurality of monitoring instances may transmit the set of events in response to recording the set of events. In other words, the monitoring system 301 may receive the set of events in real-time (or in near-real-time) because the plurality of monitoring instances transmit the set of events as available.

As further shown in FIG. 5, process 500 may include filtering the set of events to generate a filtered set of events (block 520). For example, the monitoring system 301 (e.g., using processor 420 and/or memory 430) may filter the set of events to generate a filtered set of events, as described above in connection with reference number 120 of FIG. 1B and/or reference number 165 of FIG. 1F. As an example, the monitoring system 301 may apply at least one rule to filter the set of events. Some examples of events that satisfy the at least one rule may include configuration changes associated with the cloud environment, a container task definition update, or a lambda function version update, among other examples.

As further shown in FIG. 5, process 500 may include adding the filtered set of events to a queue service (block 530). For example, the monitoring system 301 (e.g., using processor 420, memory 430, and/or communication component 460) may add the filtered set of events to a queue service, as described above in connection with reference number 125 of FIG. 1C and/or reference number 170 of FIG. 1G. As an example, the queue service may ensure that each event (in the filtered set of events) is processed once (and, preferably, only once).

As further shown in FIG. 5, process 500 may include determining, for each event in the filtered set of events, a corresponding impact (block 540). For example, the monitoring system 301 (e.g., using processor 420, memory 430, and/or communication component 460) may determine, for each event in the filtered set of events, a corresponding impact, as described above in connection with reference number 140 of FIG. 1D and/or reference number 185 of FIG. 1H. As an example, the monitoring system 301 may determine the corresponding impact directly from each event. Additionally, or alternatively, the monitoring system 301 may determine the corresponding impact based on metadata associated with each event. Additionally, or alternatively, the monitoring system 301 may determine the corresponding impact based on a dependency mapping. Additionally, or alternatively, the monitoring system 301 may determine the corresponding impact using a machine learning model (e.g., as described in connection with FIG. 1D).

As further shown in FIG. 5, process 500 may include transmitting, for each corresponding impact, a notification to a set of users associated with the corresponding impact (block 550). For example, the monitoring system 301 (e.g., using processor 420, memory 430, and/or communication component 460) may transmit, for each corresponding impact, a notification to a set of users associated with the corresponding impact, as described above in connection with reference number 145 of FIG. 1D and/or reference number 190 of FIG. 1H. As an example, each user in the set of users may have indicated a preference (e.g., stored in a data structure accessible by the monitoring system 301) for a communication channel. Therefore, the monitoring system 301 may use, for each user, the communication channel indicated by the preference of the user.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1H and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

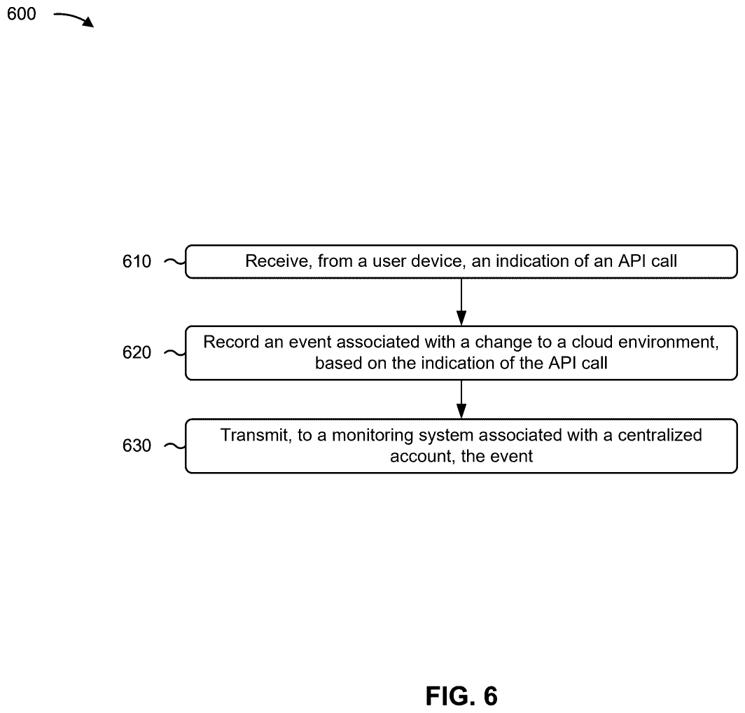

FIG. 6 is a flowchart of an example process 600 associated with reporting changes to a cloud environment. In some implementations, one or more process blocks of FIG. 6 may be performed by (a device supporting) a monitoring instance (e.g., within a cloud instance 340). In some implementations, one or more process blocks of FIG. 6 may be performed by another device or a group of devices separate from or including the cloud instance 340, such as a monitoring system 301, a user device 330, an external system 350, and/or a communication system 360. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include receiving, from a user device, an indication of an API call (block 610). For example, the cloud instance 340 (e.g., using processor 420, memory 430, input component 440, and/or communication component 460) may receive, from a user device, an indication of an API call, as described above in connection with FIG. 1A and/or FIG. 1E. As an example, the cloud instance 340 may include a monitoring instance configured by a monitoring system. For example, the monitoring system may have transmitted, and the cloud instance 340 may have received, a command to deploy the monitoring instance. Additionally, the monitoring system may have transmitted, and the cloud instance 340 may have received, a configuration for the monitoring instance. Therefore, the monitoring instance may subscribe to API events within the cloud instance 340.

As further shown in FIG. 6, process 600 may include recording an event associated with a change to a cloud environment, based on the indication of the API call (block 620). For example, the cloud instance 340 (e.g., using processor 420 and/or memory 430) may record an event associated with a change to a cloud environment, based on the indication of the API call, as described above in connection with reference number 110 of FIG. 1B and/or reference number 155 of FIG. 1F. As an example, the monitoring instance may receive indications whenever API functions are called within (and/or by) the cloud instance 340. In some implementations, the monitoring instance may record the event using a configuration from a monitoring system. For example, the configuration may indicate some types of API calls to record (e.g., commands to change and/or update the cloud environment) and other types of API calls to ignore (e.g., status requests, among other examples).

As further shown in FIG. 6, process 600 may include transmitting, to a monitoring system associated with a centralized account, the event (block 630). For example, the cloud instance 340 (e.g., using processor 420, memory 430, and/or communication component 460) may transmit, to a monitoring system associated with a centralized account, the event, as described above in connection with reference number 115 of FIG. 1B and/or reference number 160 of FIG. 1F. As an example, the event may be transmitted in an HTTP message and/or using an API call. In some implementations, the cloud instance 340 may transmit the event in response to recording the event. In other words, the cloud instance 340 may transmit the event in real-time (or in near-real-time) because the cloud instance 340 transmits the event as available.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1H and/or FIG. 2. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

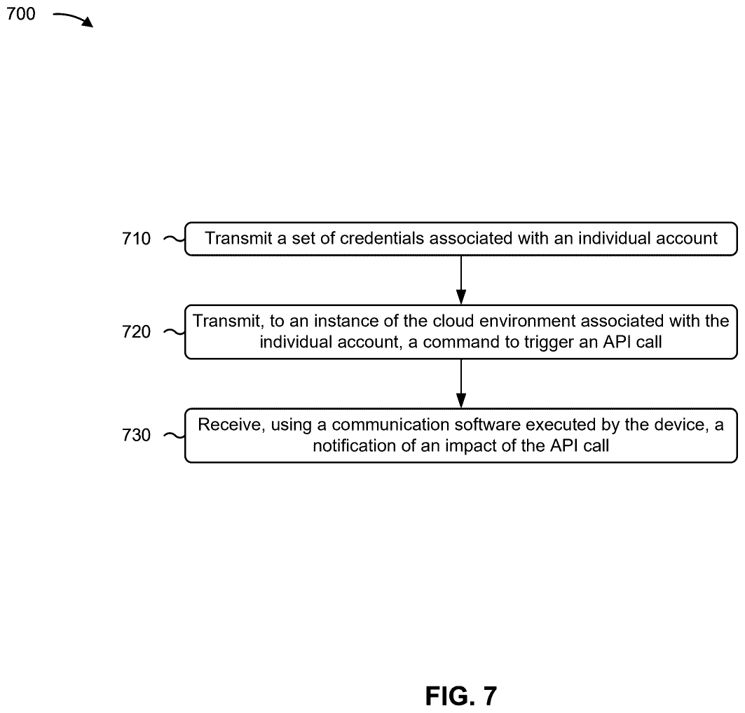

FIG. 7 is a flowchart of an example process 700 associated with commanding changes to a cloud environment. In some implementations, one or more process blocks of FIG. 7 may be performed by a user device 330. In some implementations, one or more process blocks of FIG. 7 may be performed by another device or a group of devices separate from or including the user device 330, such as a monitoring system, a device supporting a cloud instance 340, an external system 350, and/or a communication system 360. Additionally, or alternatively, one or more process blocks of FIG. 7 may be performed by one or more components of the device 400, such as processor 420, memory 430, input component 440, output component 450, and/or communication component 460.

As shown in FIG. 7, process 700 may include transmitting a set of credentials associated with an individual account (block 710). For example, the user device 330 (e.g., using processor 420, memory 430, and/or communication component 460) may transmit a set of credentials associated with an individual account, as described above in connection with FIG. 1A and/or FIG. 1E. As an example, the set of credentials may include a username and password, an SSO request, a certificate, a private key, and/or biometric information, among other examples.

As further shown in FIG. 7, process 700 may include transmitting, to an instance of the cloud environment associated with the individual account, a command to trigger an API call (block 720). For example, the user device 330 (e.g., using processor 420, memory 430, and/or communication component 460) may transmit, to an instance of the cloud environment associated with the individual account, a command to trigger an API call, as described above in connection with reference number 105a of FIG. 1A and/or reference number 150a of FIG. 1E. As an example, a user may provide input (e.g., using an input component of the user device 330) that triggers the user device 330 to transmit the command. For example, the user may provide the input using a terminal window, a bash shell, or another type of command line. In another example, the user may interact with a console, and the user device 330 may detect interaction with the console and transmit the command in response to the interaction. As an alternative, the user device 330 may transmit, and an external system may receive, an update to a binary, such that the external system may transmit, and the instance may receive, the command to trigger the API call.

As further shown in FIG. 7, process 700 may include receiving, using a communication software executed by the device, a notification of an impact of the API call (block 730). For example, the user device 330 (e.g., using processor 420, memory 430, input component 440, and/or communication component 460) may receive, using a communication software executed by the device, a notification of an impact of the API call, as described above in connection with reference number 145 of FIG. 1D and/or reference number 190 of FIG. 1H. The user device 330 may output (to the user of the user device 330) a UI including the notification. The UI may be as described in connection with FIG. 2. Accordingly, the UI may display a chat message. Additionally, or alternatively, the UI may display an email message or a text message, among other examples.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1H and/or FIG. 2. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for detecting changes to a cloud environment, the system comprising:
one or more memories; and
one or more processors, communicatively coupled to the one or more memories, configured to:
receive, from a plurality of monitoring instances deployed across a plurality of individual accounts, a set of events associated with the cloud environment;
filter the set of events to generate a filtered set of events;
add the filtered set of events to a queue service;
determine, for each event in the filtered set of events, a corresponding impact; and
transmit, for each corresponding impact, a notification to a set of users associated with the corresponding impact.

2. The system of claim 1, wherein the one or more processors are configured to:
transmit a plurality of commands to deploy the plurality of monitoring instances.

3. The system of claim 1, wherein the one or more processors, to filter the set of events, are configured to:
apply at least one rule to the set of events in order to generate the filtered set of events.

4. The system of claim 1, wherein the one or more processors, to determine the corresponding impact, are configured to:
extract, from a cloud configuration event in the filtered set of events, the corresponding impact for the cloud configuration event.

5. The system of claim 1, wherein the one or more processors, to determine the corresponding impact, are configured to:
receive, from an external system, metadata associated with a binary update event in the filtered set of events; and
determine the corresponding impact for the binary update event based on the metadata.

6. The system of claim 5, wherein the one or more processors are further configured to:
transmit, to the external system, a request for the metadata,
wherein the metadata associated with the binary update event is received in response to the request.

7. The system of claim 5, wherein the external system comprises a code repository.

8. The system of claim 1, wherein the one or more processors, to determine the corresponding impact, are configured to:
determine, using a dependency mapping, a list of affected applications for each event in the filtered set of events.

9. A method of detecting changes to a cloud environment, comprising:
receiving, from a user device and at a monitoring instance associated with an individual account, an indication of an application programming interface (API) call;
recording, by the monitoring instance, an event associated with a change to the cloud environment, based on the indication of the API call; and
transmitting, from the monitoring instance and to a monitoring system associated with a centralized account, the event.

10. The method of claim 9, further comprising:
transmitting, from the monitoring instance and to the monitoring system, metadata associated with the event.

11. The method of claim 10, further comprising:
receiving, from the monitoring system and at the monitoring instance, a request for the metadata,
wherein the metadata associated with the event is transmitted in response to the request.

12. The method of claim 9, further comprising:
receiving, at the monitoring instance and from the monitoring system associated with the centralized account, a configuration for the monitoring instance,
wherein the event is recorded using the configuration.

13. The method of claim 9, wherein the event indicates a binary update.

14. The method of claim 9, wherein the event indicates a cloud configuration.

15. A non-transitory computer-readable medium storing a set of instructions for processing notifications about changes to a cloud environment, the set of instructions comprising:
one or more instructions that, when executed by one or more processors of a device, cause the device to:
transmit a set of credentials associated with an individual account;
transmit, to an instance of the cloud environment associated with the individual account, a command to trigger an application programming interface (API) call; and
receive, using a communication software executed by the device, a notification of an impact of the API call.

16. The non-transitory computer-readable medium of claim 15, wherein the one or more instructions, when executed by the one or more processors, cause the device to:
output a user interface including the notification.

17. The non-transitory computer-readable medium of claim 15, wherein the communication software is executed by the device separately from software that transmits the command.

18. The non-transitory computer-readable medium of claim 15, wherein the one or more instructions, that cause the device to transmit the command, cause the device to:
transmit an update to a binary to a code repository associated with the instance of the cloud environment.

19. The non-transitory computer-readable medium of claim 15, wherein the one or more instructions, that cause the device to transmit the command, cause the device to:
transmit an update to a cloud configuration using a command line.

20. The non-transitory computer-readable medium of claim 15, wherein the one or more instructions, when executed by the one or more processors, cause the device to:
detect interaction with a console associated with the instance of the cloud environment,
wherein the command is transmitted in response to the interaction.
